(19) United States
(12) Patent Application Publication
(10) Pub. No.: US 2007/0108136 A1
(43) Pub. Date: May 17, 2007

(54) Fluid filtration assembly

(76) Inventor: Steven K. Gold, Lexington, MA (US)

Correspondence Address: ROBERT PLOTKIN, PC, 91 MAIN STREET, SUITE 204, CONCORD, MA, 01742-2527, US

(21) Appl. No.: 11/398,842

(22) Filed: Apr. 6, 2006

Related U.S. Application Data
(60) Provisional application No. 60/736,733, filed on Nov. 15, 2005.

(51) Int. Cl. B01D 37/00

(52) U.S. Cl. 210/767; 210/416.1

(57) ABSTRACT

A fluid filtration assembly 1 comprises a capsule 10 having filtration means 20 and one-way flow means 30. A fluid 60 is flowed through the assembly 1 two or more times to cause multiple-pass filtration of a fluid 60.

### BACKGROUND

1. Field of the Invention

The invention relates to the filtration of fluids and, more particularly, to assemblies and related methods for the filtration of water and other beverages.

2. Related Art

Fluids are filtered in a variety of ways, and for different purposes. Fluid filtration or purification (“filtration” or “filtering”) serves to eliminate undesirable matter, such as contaminants and particulate matter, from a quantity of a fluid. This is done, for example, to improve the purity, quality, safety, taste, smell, or other properties of the fluid that is being filtered. Examples of fluid filtration include the filtering of water in order to prepare it for human consumption, or the filtering of a mixture of hot water and ground coffee beans in order to provide a coffee drink. Another example of fluid filtration is the filtering of a fuel in order to eliminate contaminants that may damage an engine or affect its operation or performance.

Many different assemblies and related methods are used to filter fluids. Some approaches, including distillation, centrifugation, and the use of antibodies, and others, are not practical for small-scale (i.e., consumer) filtration needs, especially relating to water or other beverages that are being prepared for human use. Simpler approaches that are suited to consumer water and beverage filtration fit into two general categories: (a) gravity operated; and (b) pressure operated.

Gravity-operated filtration typically involves a container having upper and lower compartments, and a filter located in between. Another embodiment of this type of filter uses an upper container (i.e., a bag) that may be positioned above, and is connected to, a filter (which is, in turn, connected to another container or fluid outlet). Unfiltered fluid is placed into the upper compartment that is located above the filter relative to the direction of gravitational force. The fluid passes through the filter at a rate of flow determined by gravity, the physical properties of the filter, and the physical properties of the fluid, among other factors. In general, it may take several minutes for a liter of water to flow through a filter of a typical consumer water filtration device of this type. Examples of devices of this type include those made or sold by Brita Products Company (an affiliate of The Clorox Company, Oakland, Calif., USA), and Pur (an affiliate of Proctor & Gamble Company, Cincinnati, Ohio, USA). Other gravity-fed water filtration assemblies are made by Katadyn Produkte AG (Wallisellen, Switzerland), and Mountain Safety Research (Seattle, Wash., USA).

Pressure operated assemblies rely on a, pressurized source of a fluid, such as a home, office, or laboratory water line—including those that feed into a faucet, shower, or appliance, for example. In a pressure operated device, pressurized water is forced through a filter. Water coming out of the filter is then re-introduced back into a water supply line, exits through an outlet (faucet or head) of a device, or is made available for consumption or other use. With regard to water filtration, these types of assemblies are commonly used for residential and commercial water filtration. Examples of devices of this type include those made or sold by Amway Corporation (an affiliate of Alticor, Ada, Mich., USA), The Brita Products Company (an affiliate of The Clorox Company, Oakland, Calif., USA), Culligan International (Northbrook, Ill., USA), Everpure, Inc. (Hannover Park, Ill., USA), General Electric Company (Fairfield, Conn., USA), Kenmore (an affiliate of Sears Holdings Corporation, Hoffman Estates, Ill., USA), Multi-Pure International (Las Vegas, Nev., USA), Pur (an affiliate of The Proctor & Gamble Company, Cincinnati, Ohio, USA), and Sun Water Systems, Inc. (Fort Worth, Tex., USA). In addition, pressurized sources of water (including steam) are used in devices for making beverages such as coffee. Examples of such devices are made or sold by Bialetti Industrie S.p.A. (Coccaglio, Italy), Black & Decker (Towson, Md., USA), Braun (an affiliate of The Proctor & Gamble Company, Cincinnati, Ohio, USA), Bunn-O-Matic Corporation (Springfield, Ill., USA), Cuisinart (Stamford, Conn., USA), Keurig Incorporated (Wakefield, Mass., USA), Krups (an affiliate of Groupe SEB, Cedex, France), and La Pavoni S.p.A. (Milan, Italy).

Pressure operated devices also include those wherein the pressurized water source is provided by manual operation. These devices include hand-pump type water filters, such as those used by campers and outdoor enthusiasts to filter or purify water from a stream or other source, as well as water filters used to modify a beverage. The latter devices include those known as “French presses,” and involve the manipulation of a filter in a manner that forces a filter through a fluid (ground coffee beans and hot water in this case). Straw-type devices wherein fluid is drawn through a filter by means of negative pressure are also noted as devices that enable water filtration by pressure-induced means. Examples of devices of this general type include those made or sold by Bialetti Industrie S.p.A. (Coccaglio, Italy), Bodum AG (Triengen, Switzerland), Bonjour Products (Napa, Calif., USA), Frieling USA, Inc. (Charlotte, N.C., USA), Katadyn Produkte AG (Wallisellen, Switzerland), Planetary Design (Missoula, Mont., USA), and Timolino, Inc. (Laguna Hills, Calif., USA).

Manually-operated filtration devices of the last type are described in U.S. Pat. No. 678,692 to Roth; U.S. Pat. No. 1,982,846 to Wales; U.S. Pat. No. 2,311,759 to Johnson; U.S. Pat. No. 5,932,098 to Ross; U.S. Pat. No. 6,324,966 to Joergensen; and, U.S. Pat. No. 6,964,223 to O'Loughlin.

These are merely a few examples of the kinds of assemblies and methods that have been developed in attempts to provide for the filtration and purification of fluids.

### SUMMARY

Assemblies and methods are disclosed for filtering fluids, including water, by means of multiple-pass filtration. In general, multiple-pass filtration enables a fluid to be filtered by two or more successive passes through an assembly.

In accordance with embodiments of the invention, a fluid filtration assembly comprises filtration means and one-way flow means. A volume of a fluid that is flowed through filtration means of the assembly two or more times undergoes multiple-pass filtration. Flow of the fluid may be accomplished, for example, by moving the assembly through the fluid, or by moving the fluid through the assembly. Either method of use the assembly to perform multiple-pass filtration of the fluid.

Embodiments of the invention provide novel benefits and enable devices and methods of use that incorporate multiple-pass filtration assemblies. For example, water cups, beverage containers, filtration pitchers, coffee-making devices, and other similar products may apply embodiments of assemblies and methods of use of the invention to provide high quality fluid filtration simply, reliably, and at low cost.

### BRIEF DESCRIPTION OF THE DRAWINGS

In the drawings, closely related figures have the same number but different alphabetic suffixes.

FIG. 1A shows a schematic representation of a multiple-pass filtration assembly and process.

FIG. 1B shows a schematic representation of a single-pass assembly and process.

FIG. 2 shows a side cut-away view of an embodiment of the invention, comprising a structure having filtration means and one-way flow means.

FIG. 3A shows a top view of an embodiment of a capsule with filtration means and one-way flow means.

FIG. 3B shows a side cut-away view of the same embodiment.

FIG. 4A shows a top view of another embodiment of a capsule with filtration means and one-way flow means.

FIG. 43 shows a side cut-away view of the same embodiment.

FIG. 5A shows a top view of yet another embodiment of a capsule with filtration means and one-way flow means.

FIG. 5B shows a side cut-away view of the same embodiment.

FIGS. 6A-6D show a method of using embodiments of the invention.

FIGS. 7A-7D show a method of using an embodiment of the invention.

FIG. 8 shows a side cut-away view of an embodiment of the invention having a moveable capsule and associated tube-like manipulation means.

FIG. 9 shows a side cut-away view of another embodiment of the invention having a moveable capsule and associated rod manipulation means.

FIG. 10 shows a side cut-away view of yet another embodiment of the invention having a moveable capsule and associated rod manipulation means.

FIG. 11 shows a side cut-away view of yet another embodiment of the invention having a fixed capsule and fluid manipulation means.

FIG. 12 shows a side cut-away view of yet another embodiment of the invention having a filtration means and one-way flow means that are integrated with a structure of a vessel, and fluid manipulation means.

FIG. 13 shows a side cut-away view of yet another embodiment of the invention having a filtration means and one-way flow means that are integrated with a structure of a vessel, and fluid manipulation means.

### DRAWING NUMERAL MEANINGS

| Drawing | |
|---|---|
| Numeral | Meaning |
| 1 | Assembly |
| 5 | Single-pass filter device of the prior art |
| 6 | Single pass filter device filter element |
| 10 | Capsule |
| 11 | Capsule first side |
| 12 | Capsule second side |
| 13 | Capsule peripheral wall |
| 14 | Capsule first side opening |
| 15 | Capsule second side opening |
| 20 | Filtration means |
| 21 | Filtration channel |
| 30 | One-way flow means |
| 31 | One-way flow channel |
| 40 | Manipulation means |
| 50 | Vessel |
| 60 | Fluid |
| 70 | Representation indicating a first direction of |
| | movement of manipulation means |
| 71 | Representation indicating a second direction of |
| | movement of manipulation means |
| 72 | Representation indicating a direction of flow of a |
| | fluid through a filtration channel |
| 73 | Representation indicating a direction of flow of a |
| | fluid through a one-way flow channel |

### DETAILED DESCRIPTION

### Introduction

In general, multiple-pass filtration means the filtration of a generally fixed volume a fluid (i.e., not a constant flow or uninterrupted stream) that occurs when the fluid, or a portion of a volume of the fluid, is passed through the same assembly two or more times.

As will be described in more detail below, embodiments of the invention have advantages including:
(1) Providing a fluid filtration assembly that enables multiple-pass filtration of a fluid;
(2) Providing a fluid filtration assembly that enables progressive filtration of a fluid by means of two or more passes of the fluid through such an assembly;
(3) Providing a fluid filtration assembly that enables a user to control the degree of filtration of a fluid;
(4) Providing a fluid filtration assembly that enables other novel fluid filtering devices;
(5) Providing a fluid filtration assembly that may be incorporated into a water filtering device;
(6) Providing a fluid filtration assembly that may be incorporated into a coffee-making device; and
(7) Providing a fluid filtration assembly that may be incorporated into a wide range of containers.

Embodiments of the invention provide assemblies, methods, and related devices for filtering fluids, including water, by means of multiple-pass filtration. Multiple-pass filtration enables a fluid to be filtered two or more times by successive passes through the same assembly, i.e., assembly 1. By contrast, single-pass type filtration does not provide for recirculation (cycling) of fluid through the same device multiple times.

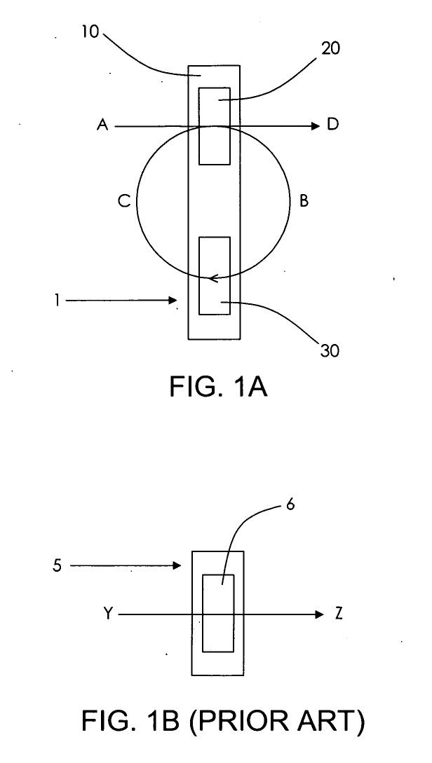

The general concept of multiple-pass filtration is shown in FIG. 1A. FIG. 1A shows a representation of a generic multiple-pass filtration assembly 1. In FIG. 1A, the arrow (A->B->C) shows a path of flow of a fluid through the generic multiple-pass filtration assembly 1. A fluid is caused to flow through filtration means 20 of the assembly 1 once (A->B), and then is caused to circulate back through another element of the assembly (B->C) in order to flow through filtration means 20 of the same assembly 1 at least one more time (C->D). In other words, the fluid is circulated (or cycled) two or more times through such a multiple-pass filtration assembly to cause multiple-pass filtration of the fluid. By contrast, FIG. 1B shows a representation of a single-pass filter device 5 of the prior art. In FIG. 1B, the arrow (Y->Z) represents the path of flow of a fluid through a filter 6 of the single-pass filter device 5 of the prior art.

Importantly, multiple-pass filtration occurs when fluid flows through an assembly two or more times, and does not equate with the number of discrete filters or filtration means of an assembly of either type (multiple-pass or single pass, either of which may have one or many filters or filtration means). In other words, an assembly of either type may have one or more discrete filters or filtration means; however, the number of filters or filtration means of an assembly does not imply multiple-pass filtration of fluid. Only re-circulation of fluid through an assembly two or more times constitutes multiple-pass filtration.

Fluids that may be used in conjunction with embodiments of the invention include any fluid, including liquids and gasses. Examples of fluids that may be filtered using embodiments of the invention include water, coffee, tea, fuel, oil, and air. In particular, embodiments of the invention may be used to filter water or beverages for human consumption.

### Capsule

Embodiments of the invention may be constructed of a capsule (also referred to as a “capsule structure”) 10 that is a structure that serves as a physical support for filtration means 20 and one-way flow means 30.

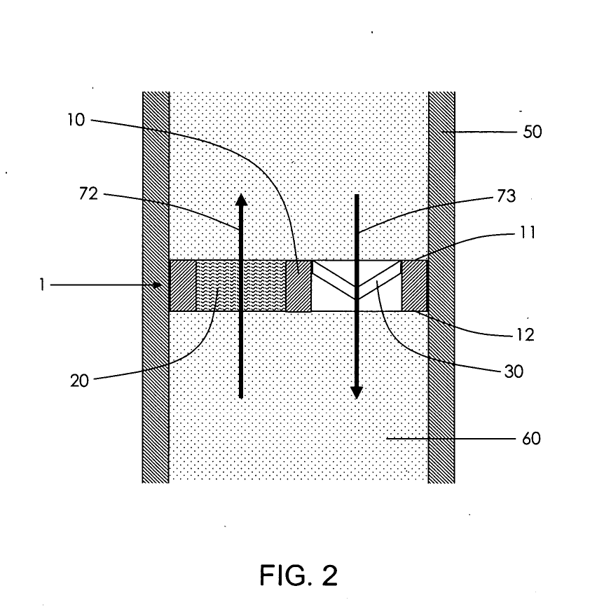

FIG. 2 shows a side cut-away view of a generic assembly 1. In FIG. 2, capsule 10 has filtration means 20 and one-way flow means 30. Capsule 10 is positioned within (a column of) a fluid 60 located within a vessel (also referred to as a “container”) 50. In general, fluid 60 is caused to flow through filtration means 20 of capsule 10 of assembly 1 a first time (one possible path of flow of fluid 60 through filtration means 20 is represented by arrow 72); then, at least a portion of fluid 60 is cycled (circulated) back through capsule 10 by means of one-way flow means 30 (one possible path of flow of fluid 60 through one-way flow means 30 is represented by arrow 73); then, at least a portion of fluid 60 is flowed back through filtration means 20. Each pass through filtration means 20 constitutes a cycle. A functional combination of filtration means 20 and one-way flow means 30 enables multiple-pass filtration of fluid 60. Two or more cycles cause multiple-pass filtration of fluid 60.

Notably, embodiments of assemblies 1 enable multiple-pass filtration of fluid 60 so long as fluid 60 may be caused to flow back and forth through capsule 10. This may be accomplished, for example, by moving capsule 10 through fluid 60, or by moving fluid 60 through capsule 10. For example, capsule 10 shown in FIG. 2 may be moved up and down within fluid 60 located in vessel 50. Alternatively, capsule 10 shown in FIG. 2 may be in a fixed position (i.e., in relation to vessel 50), attached to vessel 50, for example, and fluid 60 may be caused to move back and forth through capsule 10. Either way, assembly 1 enables multiple-pass filtration of fluid 60.

The shape, size, profile, and other features of assembly 1 may vary significantly; however, one embodiment of assembly 1 is a capsule 10, which combines filtration means 20 and one-way flow means 30 to enable multiple-pass filtration.

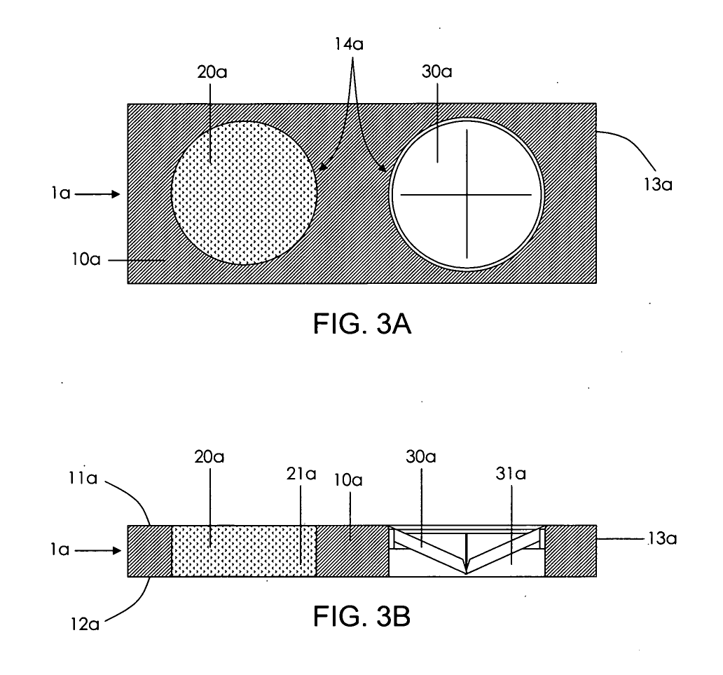

One embodiment of assembly 1 is shown in FIGS. 3A and 3B. FIG. 3A shows a top view of an embodiment of assembly 1. Assembly 1a has a rectangular-shaped capsule 10a, first side 11a, first side openings 14a, peripheral wall 13a, a single filtration means 20a within a single filtration channel 21a, and a single one-way flow means 30a within a single one-way flow channel 31a. FIG. 3B shows a side cut-away view of this embodiment of assembly 1 shown in FIG. 3A.

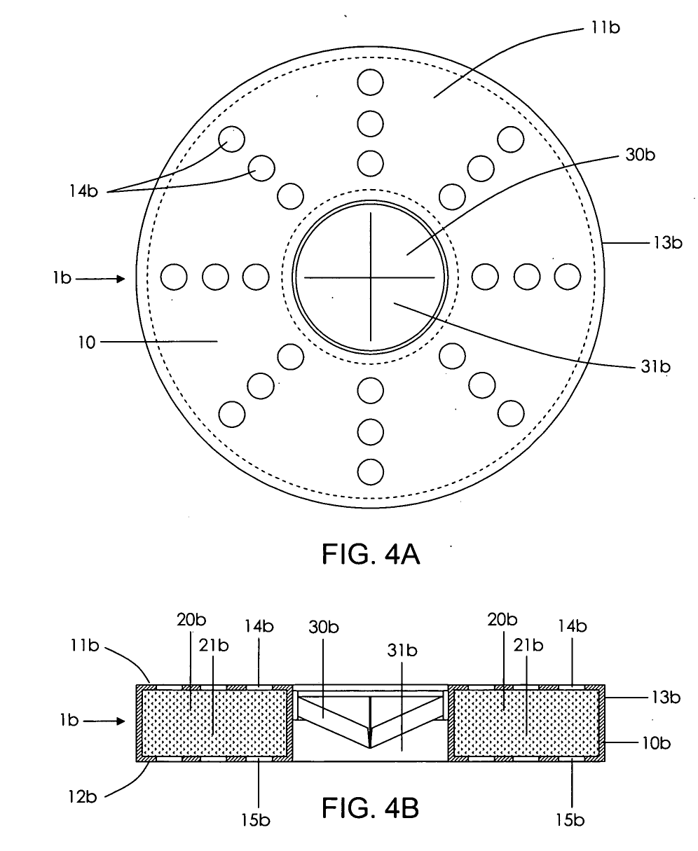

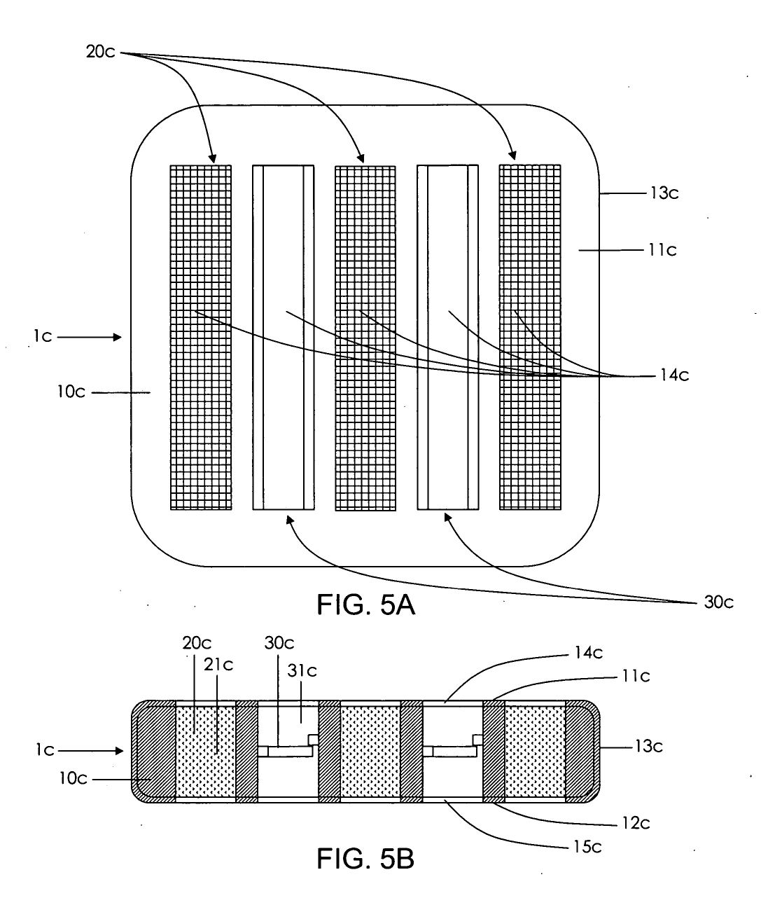

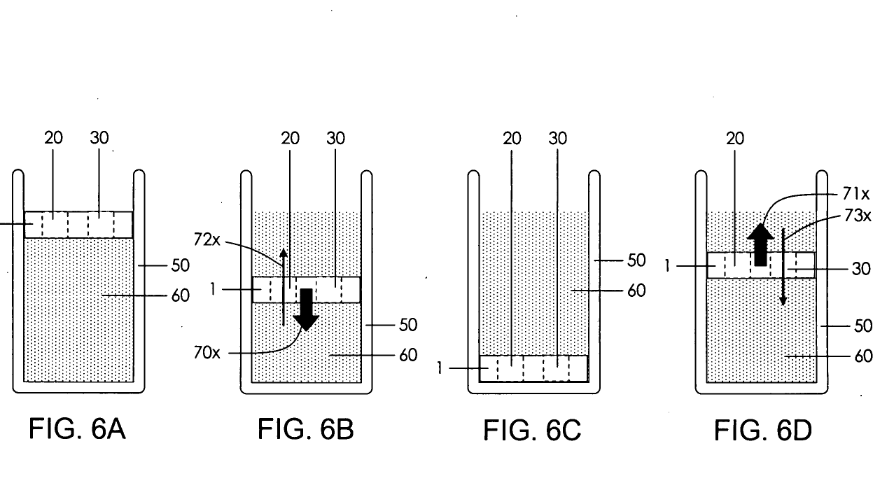

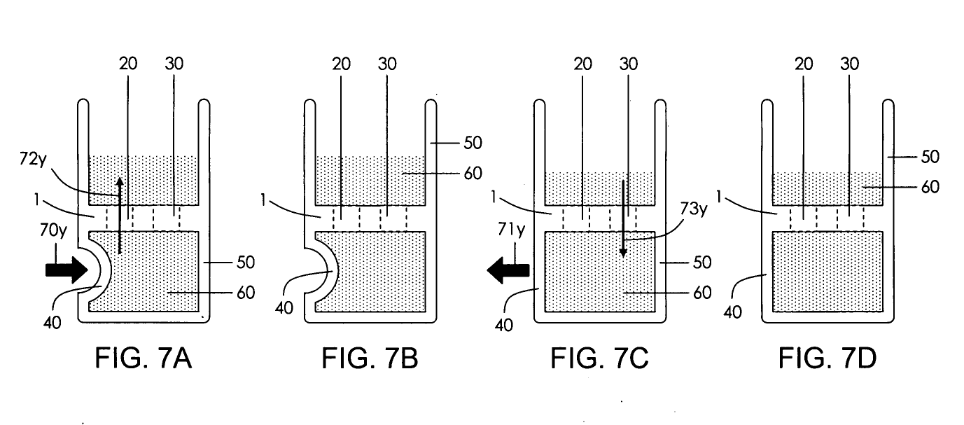

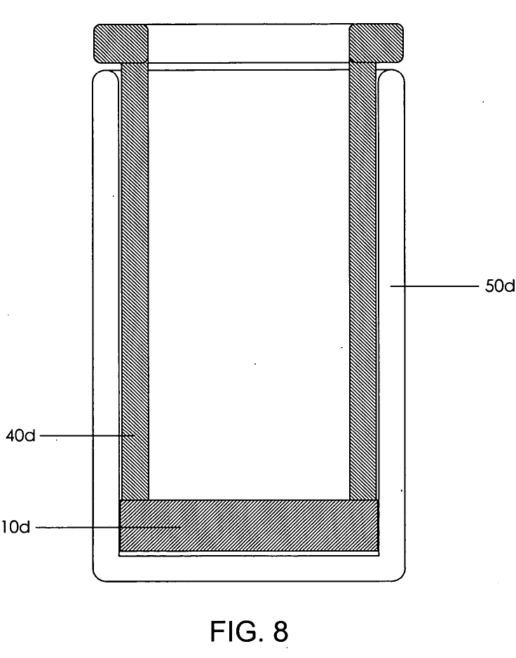

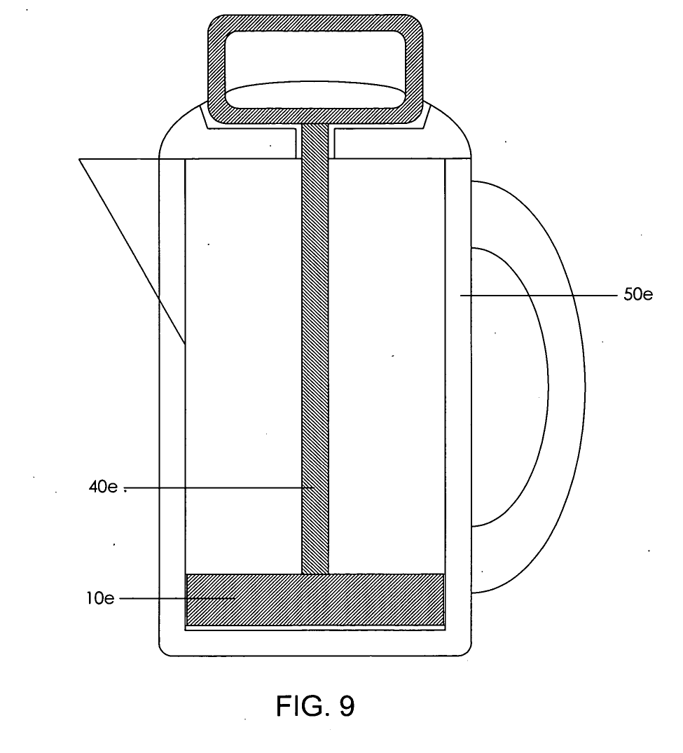

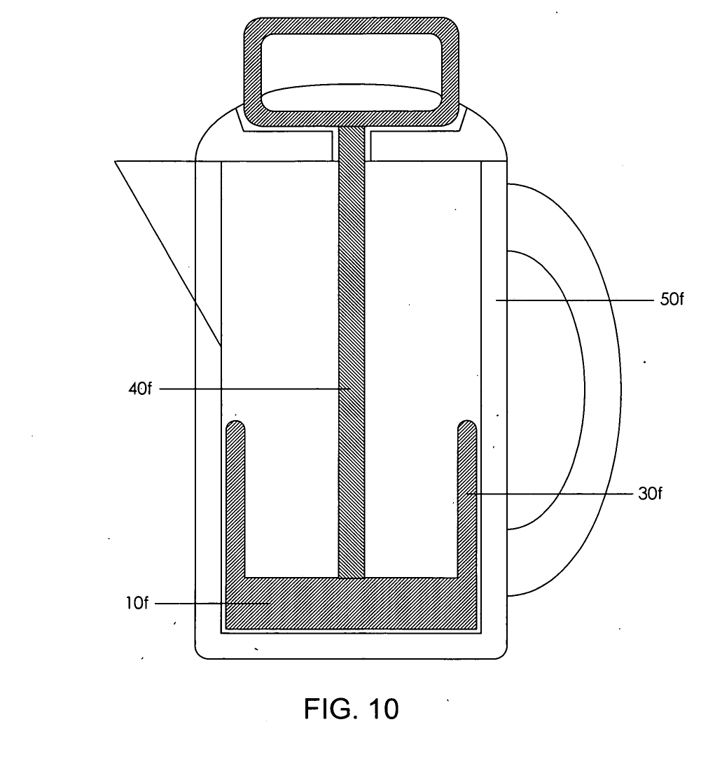

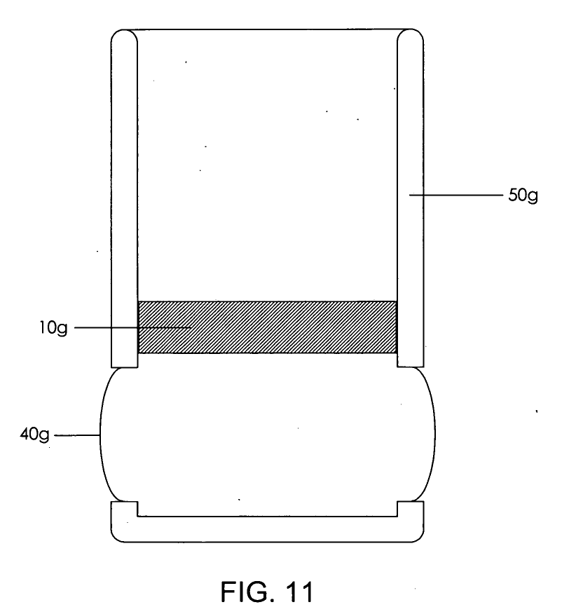

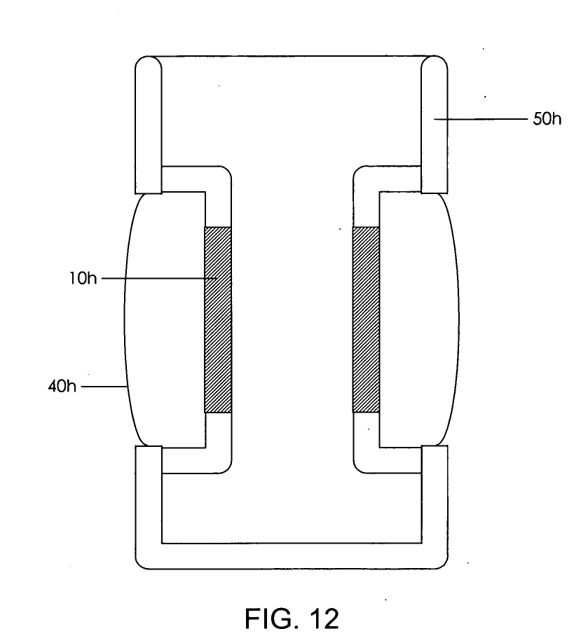

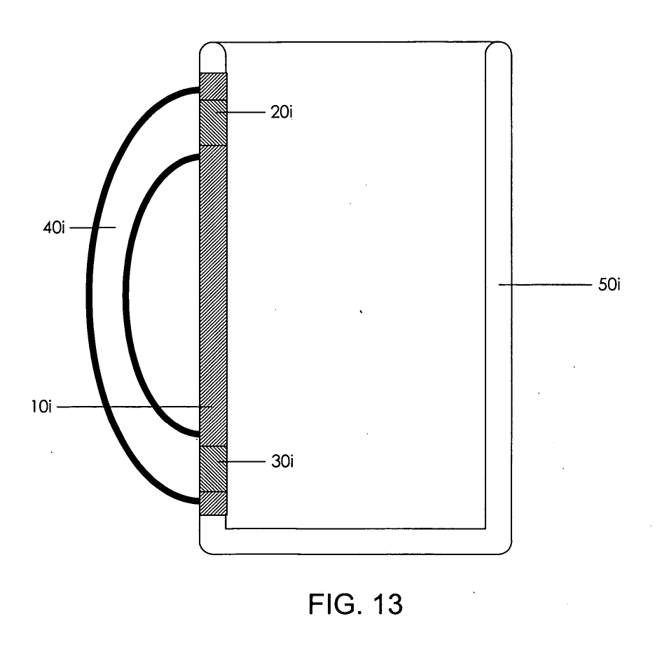

Another embodiment of assembly 1 is shown in FIGS. 4A and 4b. FIG. 4A shows a top view of an embodiment of assembly 1. Assembly 1b has a round-shaped capsule 10b, first side 11b, multiple first side openings 14b, peripheral wall 13b, and a single, centrally-positioned one-way flow means 30b within a single, centrally-positioned one-way flow channel 31b. FIG. 4b shows a side view of this embodiment of assembly 1 shown in FIG. 4A, including filtration means 20b positioned within filtration channel 21b.

Yet another embodiment of assembly 1 is shown in FIGS. 5A and 5B. FIG. 5A shows a top view of this embodiment of assembly 1. Assembly 1c has a generally square-shaped capsule 10c, first side 11c, first side openings 14c, three discrete filtration means 20c, each positioned within its own filtration channel 21c, and two discrete one-way flow means 30c, each positioned within its own one-way flow channel 31c. FIG. 5b shows a side view of this embodiment of the assembly 1 shown in FIG. 5A.

Dimensions of assembly 1 may vary significantly. In one embodiment, for example, a cross-sectional dimension is between 10 and 100 cm. In another embodiment, for example, a cross-sectional dimension is between 1 and 1000 cm. In one embodiment, for example, the thickness of capsule 10 is between 1 and 10 cm. In another embodiment, for example, the thickness of capsule 10 is between 0.1 and 500 cm. First side openings 14 and second side openings 15 may also vary widely in size and shape, and combinations of different sizes and shapes are possible. For example, one embodiment of assembly 1 has capsule 10 having a circular cross-section, is 20 cm diameter, 3 cm thick, includes a central one-way flow channel 30 that is 5 cm diameter, and further includes 100 circular first side 11 and second side 12 openings of 0.1 cm diameter each.

A capsule may be manufactured of any one or more of a range of materials, including plastic, metal, glass, or other natural or synthetic materials, or combinations of these. A capsule may include one or more interior walls (dividers) to form compartments or enhance its structural rigidity. A capsule may be manufactured in a variety of ways. A capsule may be manufactured as a single piece, or multiple pieces that are assembled. A capsule may be formed, molded, or machined, for example. In one embodiment, for example a capsule is injection molded in two pieces, a bottom piece that includes spaced interior walls, and a top cover piece; filtration means and one-way flow means are positioned into the bottom piece; and the pieces are then assembled into a final assembly of the invention.

It is noted that embodiments of assemblies relate generally to a novel combination of filtration means and one-way flow means in order to enable multiple-pass filtration of a fluid. Such means may be combined using any capsule or any other structure that combines filtration means and one-way flow means. For example, filtration means 20 and one-way flow means 30 may be built into the sidewall of a cup or mug. In such an embodiment, a part of the structure of such a vessel would also serve as the structure that combines filtration means 20 and one-way flow means 30, and enables a functional combination of these elements.

### Filtration Means

In general, filtration means is any structure or process that enables filtering of a fluid. Fluid may be filtered, for example, to improve its purity, quality, safety, taste, smell, or other characteristics. Examples of contaminants or matter that may be filtered by embodiments of filtration means include: alachlor, atrazine, benzene, carbofuran, carbon tetrachloride, chlorobenzene, chlorine, dibromide, dibromochloropropane, dichlorobenzenes, dichloroethane, dichloroethylene, dinoseb, endrin, ethlybenzene, ethylene heptachlor, hexachlorobutadiene, hexachlorocyclopentadiene, lead, lindane, methoxychlor, methyltertbutylether, pentachlorophenol, simazine, styrene, tetrachloroethane, tetrachloroethlyene, toluene, 2,4,5-TP, trichlorobenzene, trichloroethanes, bromodichloromethane, bromoform, chloroform, chlorodibromomethane, xylenes, Cryptosporidium, and Giardia. These compounds or organisms are examples of those that may be found in drinking water.

Filtration means 20 may be any material or process that filters fluid 60 in a desired manner, i.e., is capable of reducing or eliminating some or all of contaminants from fluid 60. Filtration means 20 may be made of a material (filtration media) such as carbon or paper, for example. In general, filtration means 20 may eliminate contaminants from fluid 60, as fluid 60 is passed through the material. Filtration means 20 may, for example, be made of block carbon or activated carbon. Filtration means 20 may, for example, include an ion exchange resin. Filtration means 20 may, for example, include a microfilter. Filtration means 20 may be made of one material, or a combination of materials, such as in the case of a multimedia filter that provides for both physical and chemical filtration of fluid 60. In one embodiment, filtration means 20 is a multimedia filter that includes block carbon and other constituents. Filtration means 20 may be a filter material or combination of filter materials that is enclosed in a filtration means unit, whereby the entire unit is replaceable, i.e., a cartridge that may be inserted and removed from a capsule 10. This may be desirable since most filters have a life, and it may be useful to replace filtration means 20 in lieu of replacing the entire capsule 10 or assembly 1.

### One-Way Flow Means

One-way flow means is any structure or process that enables substantially unidirectional flow of fluid. For example, one-way flow means 30 may be a one-way valve. Such a valve may have leaves that move or flex to permit the flow of fluid 60 in one direction through the valve, but prevent the flow of the fluid 60 in an opposite direction through the valve. One-way flow means 30 may be made of deformable materials such as flexible plastic or rubber for example, or inflexible materials such as a stiff plastic or metal (possibly forming a hinge or other mechanism), or any combination of these or other materials. In one embodiment, one-way flow means 30 is a valve having three leaves that are made of a flexible plastic material. In another embodiment, one-way flow means 30 is trap door. In yet another embodiment, one-way flow means 30 is a generally fixed structure, such as a containment space, that enables fluid 60 to be (re)positioned into the space in order to facilitate a subsequent round of filtration of the fluid 60. For example, an embodiment of the invention may be used by lowering one-way flow means 30 (comprising a containment space for holding a fluid) into fluid 60 to provide one-way flow of fluid 60 and circulation of fluid 60 back through filtration means 20. In this last example, fluid 60 may flow around a structure, rather than through it.

### Peripheral Wall

A peripheral wall (also referred to as a “side wall”) is an element of capsule 10 that, in one embodiment, facilitates movement of capsule 10 relative to vessel 50 containing fluid 60. In such an embodiment, sides wall 13 is intended to facilitate secure movement of capsule 10 within (i.e., relative to the inside walls of) vessel 50. In such an embodiment, peripheral wall 13 is straight (oriented at a right angle relative to the top and bottom surfaces of capsule 10) in order to enable secure (touching) direct contact with the inside walls of vessel 50 within which capsule 10 resides and moves. In other words, peripheral wall 13 is intended to substantially engage the interior surface, or inside wall or surface, of a chamber of vessel 50 in a manner that allows capsule 10 to slide up or down within such a chamber. Peripheral wall 13 may be made of the same or a different material as capsule 10. Peripheral wall 13 may also be modified in any of a variety of ways. Examples of possible modifications include: surface texture, surface coating, rings (i.e., seal or gasket), or indentations. Whether or not modified, peripheral wall 13 may serve any one or more of the following purposes: a) promote stability of capsule 10 during movement of the capsule 10 relative to a chamber of vessel 50; b) promote a secure seal between capsule 10 and the inside wall of a vessel 50 in order to prevent or minimize undesirable flow (leakage) of fluid 60 around capsule 10 in the space between the capsule 10 and the inside wall of vessel 50; and 3) to facilitate movement (displacement or sliding) of capsule 10 relative to an inside wall of vessel 50. In one embodiment of the invention, capsule peripheral wall 13 (a) provides stability of the capsule 10 as it is moved up and down within a chamber of vessel 50, (b) provides a tight seal that prevents fluid 60 from by-passing filtration means 20, and (c) facilitates sliding movement of the capsule 10 relative to the inside wall of the chamber of vessel 50. Stability may also be achieved or enhanced by other means, such as manipulation means 40, as described below.

### Manipulation Means

Manipulation means (also referred to as “propulsion means”) includes any structure or process that causes fluid to flow through a capsule of an assembly. Manipulation means 40 may manipulate or move either capsule 10 or fluid 60.

Manipulation means 40 that may move capsule 10 may include sticks, rods, and posts, for example. Another manipulation means 40 that may move capsule 10 is a tube-like structure that, for example, is connected with capsule 10 near or at the peripheral wall 13 of an embodiment of capsule 10. Any of these manipulation means 40 may take any of a variety of shapes, sizes and forms. Manipulation means 40 that facilitate movement of capsule 10 may be made of a wide range of materials, including metal or plastic, or a combination of these or other materials. Manipulation means 40 of this type may be connected to a capsule 10 using an adhesive, engagement means, or a welding process, for example, or may be an integral part of capsule 10.

Manipulation means 40 that facilitate movement of capsule 10 are connected to capsule 10 in order to displace capsule 10 in a desired manner. For example, moving manipulation means 40 of this type up relative to a vessel 50 displaces an associated capsule 10 up; moving manipulation means 40 of this type down relative to a vessel 50 displaces an associated capsule 10 down, i.e., further into vessel 50.

Manipulation means 40 may also be any structure or process that moves fluid 60 in order to cause fluid 60 to flow through an embodiment of capsule 10. Such manipulation means 40 may include any structure or process that is capable of altering a volume of a space of a vessel 50, or otherwise causes fluid 60 to flow through capsule 10. For example, manipulation means 40 of this type may be a deformable part of a vessel 50, such as a depressible material, or a piston associated with vessel 50.

Manipulation means 40 may also be remote, such as a magnet-controlled piston or other structure, or may even be the heating or cooling of fluid 60 to cause its flow through an embodiment of capsule 10 (i.e., the transformation of water into steam—and then back into water—that causes the water to expand and condense in a way that may cause it to flow back and forth through capsule 10).

An embodiment of assembly 1 may use multiple manipulation means 40. For example, an embodiment of assembly 1 may include a first manipulation means (such as a post with a handle) to enable manual lifting of capsule 10, and a second manipulation means (such as a spring) to cause capsule 10 to move in an opposite direction through fluid 60. Another embodiment may have manipulation means 40 that engages a piston (and causes fluid 60 to move through capsule 10), and second manipulation means, such as a spring (to withdraw the piston and cause fluid 60 to move in an opposite direction through capsule 10). Other combinations of manipulation means are possible.

In general, manipulation means 40 cause the flow of fluid 60 through an embodiment of assembly 1, irrespective of any particular design or method of operation.

### Multiple-Pass Filtration

The progressive filtering of fluid to ever-greater degrees by means of two or more passes of fluid through filtration means of the same device is “multiple-pass filtration.”

For example, if a filter removes 90% of contaminants from fluid in a first pass, it should eliminate 90% of the remaining contaminants in a second pass, 90% of the remaining contaminants in a third pass, etc. After a first pass, 90% of the initial contaminants should be eliminated. After a second pass of the same fluid, 99% of the initial contaminants should be eliminated. After a third pass of the same fluid, 99.9% of the initial contaminants should be eliminated, and so on.

Even a filter that only removes 50% of contaminants in each filter pass (cycle) may be capable of eliminating 99.99% of contaminants in a quantity of fluid in about 15 cycles.

These are examples of one of the many benefits of multiple-pass filtration—a process that removes more and more of the contaminants from fluid by means of multiple (repeat) passes through the same filter. Multiple-pass filtration enables the use of less filtration material (medium) per assembly. One benefit of this is that it enables lower filter resistance. Another benefit of multiple-pass filtration is that it enables a wide range of novel water and fluid filtration devices.

The various embodiments of assemblies 1 enable multiple-pass filtration of fluid 60. For example, multiple-pass filtration occurs when fluid 60 flows through filtration means 20 of an embodiment of the invention a first time, then flows through one-way flow means 30 of an embodiment of the invention, and is then allowed to flow back through filtration means 20 at least one more time. Each pass of fluid 60 through filtration means 20 constitutes a “cycle.” Two or more cycles constitute multiple-pass filtration. A user may perform a greater number or cycles in order to achieve a greater degree of filtration of fluid 60.

In general, a cycle is enabled by one-way flow means 30 producing a relatively high resistance to fluid 60 flow from one direction (i.e., one side of capsule 10), but not an opposite direction (i.e., the other side of capsule 10). When capsule 10 of assembly 1 is moved into fluid 60, or fluid 60 is forced into capsule 10 from a first direction, fluid 60 will flow preferentially through filtration means 20 (due to the high resistance to flow imposed by one-way flow means 30); when capsule 10 is moved out of fluid 60, or fluid 60 is forced into capsule 10 from an opposite direction, fluid 60 will flow preferentially through one-way flow means 30 (due to relatively lower resistance that encourages preferential flow through one-way flow means 30 versus filtration means 20). Note that the terms “up” and “down” are used for descriptive purposes only, and may be reversed or changed, as appropriate, depending on the orientation of capsule 10 (i.e., filtration means 20 and one-way flow means 30), or the orientation of a device comprising assembly 1 of the invention.

In an embodiment of the invention, fluid 60 entering capsule 10 from a first direction will flow either substantially or completely through filtration means 20, and fluid 60 entering capsule 10 from an opposite direction will flow either substantially or completely through one-way flow means 30. Flowing fluid 60 back and forth through assembly 1 causes multiple-pass filtration of fluid 60.

In general, multiple-pass filtration may be accomplished by embodiments of assembly 1 in either of two ways. First, an embodiment of assembly 1 may be moved (back and forth, for example) through fluid 60. Second, fluid 60 may be moved (back and forth) through assembly 1. Whether assembly 1 is moving or fixed relative to other structures (i.e., vessel 50), it is the relative movement of assembly 1 and fluid 60 that causes filtration. The techniques disclosed herein are independent of the manner in which assembly 1 is used—whether an embodiment of assembly 1 is being moved through fluid 60, or fluid 60 is being moved through an embodiment of assembly 1. Various methods of use fall within the scope of the invention. Assembly 1 should not be discriminated vis-à-vis its movement through fluid, or the movement of fluid through it.

### Methods of Use

As described, an embodiment of assembly 1 may be either moveable through fluid 60, or fluid 60 may be moveable through an embodiment of assembly 1.

One embodiment of the invention includes capsule 10 that may be moved through fluid 60 two or more cycles to cause multiple-pass filtration. In the case of such an embodiment that is moveable through fluid 60, a method of using such an embodiment includes the steps of:
(1) Positioning an embodiment of assembly 1 within vessel 50 filled with fluid 60, as shown in FIG. 6A;
(2) Moving assembly 1 in a direction (i.e., down) that causes fluid 60 to pass through filtration means 20, and that filters fluid 60, as shown in FIG. 6B (arrow 70x represents a direction of movement of assembly 1, and arrow 72x represents a direction of concurrent flow of fluid 60 through filtration means 20). FIG. 6C shows assembly 1 in a resting position at the bottom of vessel 50;
(3) Moving assembly 1 in an opposite direction (i.e., up) to cause fluid 60 to pass through one-way flow means 30, as shown in FIG. 6D (arrow 71x represents a direction of movement of assembly 1, and arrow 73x represents a direction of concurrent flow of fluid 60 through one-way flow means 30);
(4) Repeating step 2 (or steps 2 and 3), at least once, in order to cause multiple-pass filtration and achieve a desired level of filtration of fluid 60.

In the case of an embodiment of assembly 1 that is moveable through fluid 60, another method of using such an embodiment includes the steps of:
(1) Pouring fluid 60 into vessel 50 that has assembly 1 of an embodiment of the invention near its bottom, as shown in FIG. 6c;
(2) Moving assembly 1 in a first direction (i.e., up) to cause fluid 60 to pass through one-way flow means 30, as shown in FIG. 4d (arrow 71x represents a direction of movement of assembly 1, and arrow 73x represents a direction of concurrent flow of fluid 60 through one-way flow means 30). FIG. 6A shows assembly 1 in a resting position near the top of vessel 50;
(3) Moving assembly 1 in a second direction (i.e., down), opposite to a first direction, to cause fluid 60 to pass through filtration means 20, and to filter fluid 60, as shown in FIG. 6b (arrow 70x represents a direction of movement of assembly 1, and arrow 72x represents a direction of concurrent flow of fluid 60 through filtration means 20);
(4) Repeating steps 2 and 3, at least once, in order to cause multiple-pass filtration and achieve a desired level of filtration of fluid 60.

Another embodiment of assembly 1 has a capsule 10 that remains in a relatively fixed position (i.e., relative to a vessel 50) and has fluid 60 flowed through it two or more cycles in order to cause multiple-pass filtration. In the case of such an embodiment that has fluid 60 moved through it, a method of using such an embodiment includes the steps of:
(1) Applying a force to cause at least a portion of fluid 60 to flow through filtration means 20, as shown in FIG. 7A (arrow 70y represents a direction of movement of assembly 1, and arrow 72y represents a direction of concurrent flow of fluid 60 through filtration means 20). FIG. 7B shows fluid 60 in a steady state after it has flowed through filtration means 20;
(2) Releasing or reversing the force applied in Step 1 in order to cause fluid 60 to flow through one-way flow means 30, as shown in FIG. 7C (arrow 71y represents a direction of movement of assembly 1, and arrow 73y represents a direction of concurrent flow of fluid 60 through one-way flow means 30).

FIG. 7D shows fluid 60 in a steady state after it has flowed through one-way flow means 30;
(3) Repeating step 1 (or steps 1 and 2), at least once, in order to cause multiple-pass filtration and achieve a desired level of filtration of fluid 60.

Another method of using this type of an embodiment of assembly 1 includes the steps of:
(1) Applying a force to cause fluid 60 to flow through one-way flow means 30, as shown in FIG. 7C (arrow 71y represents a direction of movement of assembly 1, and arrow 73y represents a direction of concurrent flow of fluid 60 through one-way flow means 30). FIG. 7D shows fluid 60 in a steady state after it has flowed through one-way flow means 30;
(2) Releasing or reversing the force applied in Step 1 in order to cause fluid 60 to flow through filtration means 20, as shown in FIG. 7A (arrow 70y represents a direction of movement of assembly 1, and arrow 72y represents a direction of concurrent flow of fluid 60 through filtration means 20). FIG. 7B shows fluid 60 in a steady state after it has flowed through filtration means 20;
(3) Repeating steps 1 and 2, at least once, in order to cause multiple-pass filtration and achieve a desired level of filtration of fluid 60.

The terms “up” and “down” are used for descriptive purposes only; in actual use, the orientation of a capsule or vessel may be reversed. Consequently, the method of use of an embodiment would be adapted, as appropriate.

Assemblies implemented in accordance with embodiments of the invention and the methods of use described above introduce several benefits. One benefit is the enablement of multiple-pass filtration of a fluid. Another benefit is the ability to make and use devices that incorporate embodiments of the invention to provide a range of new inventions that enable superior filtration of a fluid. Examples of such devices include vessels, drinking cups, mugs, water filtering containers, coffee-making devices, tea-making devices, and more. Several such embodiments that apply the invention are described in the following section.

### REPRESENTATIVE EMBODIMENTS

In general, various embodiments of assemblies of the invention may be associated with a wide range of devices in order to enable multiple-pass filtration of a fluid. A few examples of devices that may incorporate embodiments of assemblies of the invention include: vessels, drinking cups, mugs, water filtration containers, portable drinking containers, coffee presses, tea making devices, and other similar products.

Several embodiments of devices that incorporate various embodiments of assemblies of the invention are described. In all of the embodiments described, a fluid may be moved through assembly 1 of an embodiment of the invention by manipulation means 40 (that either move assembly 1, or move fluid 60) in order to enable multiple-pass filtration.

FIGS. 8-10 show representative embodiments of devices that incorporate embodiments of assemblies 1 of the invention along with manipulation means that enable the movement of a moveable capsule through fluid.

FIG. 8 shows a side cut-away view of vessel 50d, such as a drinking cup. An embodiment of assembly 1 is moveably positioned in vessel 50d, and includes capsule 10d (with filtration means and one-way flow means that are not shown) and associated tube-like manipulation means 40d. In the embodiment shown in FIG. 8, a user would raise or lower manipulation means 40d to move capsule 10d through fluid, such as water. By moving manipulation means 40d and, by association, capsule 10d up and down according to a method of use of such an embodiment, this enables multiple-pass filtration of fluid. Such an embodiment may be used, for example, to filter water for human consumption. Such an embodiment may also be used, for example, to filter a composition of hot water and ground coffee beans, in order to provide a coffee drink that is ready for consumption. Tube-like manipulation means 40d shown in FIG. 8 provide access to the fluid by means of an open top, and enable the addition of ingredients such as cream or sugar. The open top provided by manipulation means 40d also allows a user to consume a beverage directly from vessel 50d. Capsule 10d may be permanently attached to manipulation means 40d, or temporarily attached to manipulation means 40d. If temporary, used capsule 10d may be detached and discarded, and new capsule 10d may then be attached. Also, filtration means of such an embodiment may be permanently attached to capsule 10d, or temporarily attached to capsule 10d. If temporary, used filtration means may be detached and discarded, and new filtration means may then be attached. An embodiment of the device generally depicted in FIG. 8 may be used, for example, as a drinking cup, filtration container, coffee-making device, or tea-making device.

FIG. 9 shows a side cut-away view of another vessel 50e, such as a water container. Another embodiment of assembly 1 is moveably positioned in vessel 50e, and includes capsule 10e with filtration means and one-way flow means, and associated rod manipulation means 40e. In the embodiment shown in FIG. 8, a user would raise or lower manipulation means 40e (possibly with the aid of a handle like the one shown in FIG. 8) to move assembly 1 through fluid, such as water. By moving manipulation means 40e and, by association, capsule 10e up and down according to a method of use of the invention, this causes multiple-pass filtration of fluid. An embodiment of the device generally depicted in FIG. 9 may be used, for example, to filter water for drinking purposes. Such an embodiment may also be used, for example, to filter a composition of hot water and ground coffee beans, in order to provide a coffee drink that is ready for consumption. Rod-like manipulation means 40e shown in FIG. 9 provide a structure that may be positioned through a lid of a vessel 50e, as shown in FIG. 9. Capsule 10e of such an embodiment may be permanently attached to manipulation means 40e, or temporarily attached to manipulation means 40e. If temporary, a used capsule 10e may be detached and discarded, and a new capsule 10e may then be attached. Also, filtration means of such an embodiment may be permanently attached to capsule 10e, or temporarily attached to capsule 10e. If temporary, used filtration means may be detached and discarded, and new filtration means may then be attached. An embodiment of the device generally depicted in FIG. 9 may be used, for example, as a drinking cup, filtration container, coffee-making device, or tea-making device.

FIG. 10 shows a side cut-away view of a similar vessel 50f to the one shown in FIG. 9 (50e), and another embodiment of assembly 1. In particular, this embodiment of assembly 1 as shown in FIG. 10 has different one-way flow means 30f (as compared with the previously described embodiments). In this embodiment, one-way flow means 30f comprises a wall structure that provides a containment space for fluid. In such an embodiment of assembly 1, manipulation means 40f (same as shown in FIG. 8) move capsule 10f up and down to cause, in this case, capsule 10f to either collect (when lowered, for example) or filter (when raised, for example) fluid. For example, if capsule 10f is lowered down into fluid, fluid would be caused to move around the side of capsule 10f and flow into the containment space provided by one-way flow means 30f of this embodiment. Once fluid is located in the containment space, manipulation means 40f may then be used to raise capsule 10f up (close to the lid, for example) to thereby enable fluid to flow through filtration means of this particular embodiment (as a result of gravity, for example). Repeating these steps as needed would pass fluid through filtration means two or more times and cause multiple-pass filtration of the fluid. An embodiment of the device generally depicted in FIG. 10 may be used, for example, as a drinking cup, filtration container, coffee-making device, or tea-making device.

FIGS. 11-13 show representative embodiments of devices that incorporate embodiments of assembly 1 in conjunction with manipulation means that cause a fluid to move through a fixed position capsule.

FIG. 11 shows a side cut-away view of yet another device that incorporates an embodiment of assembly 1. Vessel 50g includes capsule 10g located in a fixed position relative to vessel 50g, i.e., attached to vessel 50g. In this particular embodiment, fluid is caused to be moved through capsule 10g that includes both filtration means and one-way flow means. FIG. 11 shows vessel 50g having a lower chamber with deformable portions of its side wall. By depressing the side wall, fluid is caused to be moved up through capsule 10g. When the side wall of vessel 50g is released or otherwise caused to move back to its original position, for example, fluid is drawn back down through capsule 10g. Repeating such (pumping) action provides a method of using a device of the type shown in FIG. 11. Capsule 10g of such an embodiment may be permanently attached to the vessel 50g, or temporarily attached to vessel 50g. If temporary, used capsule 10g may be detached and discarded, and new capsule 10g may then be attached. Also, filtration means of such an embodiment may be permanently attached to capsule 10g, or temporarily attached to capsule 10g. If temporary, used filtration means may be detached and discarded, and new filtration means may then be attached. An embodiment of the device generally depicted in FIG. 11 may be used, for example, as a drinking cup, filtration container, coffee-making device, or tea-making device.

FIG. 12 shows a side cut-away view of yet another device that incorporates an embodiment of assembly 1. Vessel 50h includes capsule 10h located in a fixed position, i.e., integrated into the side wall of the vessel 50h. In this particular embodiment, fluid is caused to be moved through capsule 10h that includes both filtration means and one-way flow means. FIG. 12 shows vessel 50g having a single (or multiple) side chamber(s) with deformable portions of associated side wall. By depressing the side wall, fluid is caused to be moved side-ways through capsule 10h. When the side wall of vessel 50h is released or otherwise caused to move back to its original position, for example, fluid is drawn back through capsule 10h. Repeating such (pumping) action provides a method of using a device of the type shown in FIG. 12. Capsule 10h of such an embodiment may be permanently attached to vessel 50h, or temporarily attached to vessel 50h. If temporary, used capsule 10h may be detached and discarded, and new capsule 10h may then be attached. Also, filtration means of such an embodiment may be permanently attached to capsule 10h, or temporarily attached to capsule 10h. If temporary, used filtration means may be detached and discarded, and new filtration means may then be attached. An embodiment of the device generally depicted in FIG. 12 may be used, for example, as a drinking cup, filtration container, coffee-making device, or tea-making device.

FIG. 13 shows a side cut-away view of yet another device that incorporates an embodiment of assembly 1. Vessel 50i, such as a mug, includes capsule 10i in a fixed position, i.e., integrated into the side wall of vessel 50i. In this particular embodiment, fluid is caused to be moved through capsule 10i that has both filtration means and one-way flow means. FIG. 13 shows vessel 50i having a handle that is deformable in some way in order to enable the “pumping” of fluid through filtration means and one-way flow means of capsule 10i. By depressing the side wall of vessel 50i, fluid is caused to be moved through capsule 10i. When the side wall of vessel 50i is released or otherwise caused to move back to its original position, for example, fluid is drawn back through capsule 10i. Repeating such action provides a method of using a device of the type shown in FIG. 13 to enable multiple-pass filtration. Capsule 10i of such an embodiment may be permanently attached to vessel 50i, or temporarily attached to vessel 50i. If temporary, a used capsule 10i may be detached and discarded, and a new capsule 10i may then be attached. Also, filtration means of such an embodiment may be permanently attached to capsule 10i, or temporarily attached to capsule 10i. If temporary, used filtration means may be detached and discarded, and new filtration means may then be attached. An embodiment of the device generally depicted in FIG. 13 may be used, for example, as a drinking cup, filtration container, coffee-making device, or tea-making device.

### ADDITIONAL EMBODIMENTS

Although the description above contains many details, these provide examples of some of the embodiments of the invention, and do not limit the scope of the invention. Furthermore, titles and headings are used solely to aid a reader, and do not limit the scope of the invention.

It should be apparent to one skilled in the art that the invention may vary in many aspects, including size, shape, materials, methods of manufacture, and methods of use. In addition, each of the elements of the invention may vary with regard to their number, design, construction, use, combination, and more. Thus the scope of the invention is defined by the attached claims, rather than by the examples given.

What is claimed is:

1. A multiple-pass filtration assembly for use with a vessel containing a fluid, the assembly comprising:
filtration means comprising first means for filtering the fluid as the fluid flows through the filtration means in a first direction;
one-way flow means for providing a path for a first portion of the fluid to flow through the one-way flow means in a second direction, different from the first direction, after the fluid flows through the filtration means in the first direction;
wherein the filtration means further comprises second means for filtering a second portion of the first portion of the fluid as the second portion flows through the filtration means in the first direction.

2. The assembly of claim 1, wherein the filtration means and the one-way flow means are integrally connected.

3. The assembly of claim 1, wherein the first and second directions relate to each other at an angle greater than ninety degrees.

4. The assembly of claim 1, wherein the first means and the second means of the filtration means are a single filtration means.

5. The assembly of claim 1, wherein the assembly is displaceable relative to the vessel containing the fluid, and wherein movement of the assembly relative to the vessel is adapted to cause flow of the fluid through the assembly, to thereby facilitate multiple-pass filtration.

6. The assembly of claim 1, wherein the assembly is in a generally fixed position relative to the vessel, and wherein the fluid is movable through the assembly, to thereby facilitate multiple-pass filtration.

7. The assembly of claim 1, further comprising:
propulsion means, coupled to the assembly, for facilitating flow of the fluid through the assembly.

8. The assembly of claim 7, wherein the propulsion means comprises a component selected from the group consisting of a stick, rod, post, tube, and scaffold.

9. The assembly of claim 1, further comprising:
propulsion means, coupled to the vessel, for facilitating the flow of the fluid through the assembly.

10. The assembly of claim 9, wherein the propulsion means comprises a component selected from the group consisting of a pump, piston, and deformable structure.

11. The assembly of claim 1, wherein the fluid comprises water.

12. The assembly of claim 1, wherein the fluid comprises coffee.

13. The assembly of claim 1, wherein the fluid comprises tea.

14. A method for using a multiple-pass filtration assembly in conjunction with a vessel, the assembly comprising filtration means and one-way flow means, the method comprising:
(A) causing fluid in the vessel to flow through the filtration means in a first direction, whereby the fluid is filtered by the filtration means;
(B) after (A), causing a first portion of the fluid to flow through the one-way flow means in a second direction, different from the first direction; and
(C) after (B), causing a second portion of the first portion of the fluid to flow through the filtration means in the first direction, whereby the second portion is filtered by the filtration means.

15. The method of claim 14, wherein (A) comprises moving the assembly in the second direction to cause the fluid to flow through the filtration means in the first direction.

16. The method of claim 14, wherein (A) comprises applying a force to the fluid to cause the fluid to flow through the filtration means in the first direction.

17. The method of claim 14, wherein (B) comprises moving the assembly in the first direction to cause the fluid to flow through the one-way flow means in the second direction.

18. The method of claim 14, wherein (B) comprises causing a force to be applied to the fluid to cause the fluid to flow through the one-way flow means in the second direction.

19. The method of claim 14, wherein (C) comprises moving the assembly in the second direction to cause the fluid to flow through the filtration means in the first direction.

20. The method of claim 14, further comprising:
(D) repeating (A) and (B) until a predetermined level of filtration of the fluid is obtained.

21. A method for using a multiple-pass filtration assembly in conjunction with a vessel, the assembly comprising filtration means and one-way flow means, the method comprising:
(A) causing fluid in the vessel to flow through the one-way flow means in a first direction;
(B) after (A), causing a first portion of the fluid to flow through the filtration means in a second direction, different from the first direction, whereby the first portion of the fluid is filtered by the filtration means; and
(C) repeating (A) and (B) until a predetermined level of filtration of the fluid is obtained.

22. The method of claim 21, wherein (A) comprises moving the assembly in the second direction to cause the fluid to flow through the one-way flow means in the first direction.

23. The method of claim 21, wherein (A) comprises causing a force to be applied to the fluid to cause the fluid to flow through the one-way flow means in the first direction.

24. The method of claim 21, wherein (B) comprises moving the assembly in the first direction to cause the first portion of the fluid to flow through the filtration means in the second direction, whereby the first portion of the fluid is filtered by the filtration means.

25. The method of claim 21, wherein (B) comprises causing a force to be applied to the fluid to cause the first portion of the fluid to flow through the filtration means, whereby the first portion of the fluid is filtered by the filtration means.
